(19) United States
(12) Patent Application Publication
(10) Pub. No.: US 2018/0285358 A1
(43) Pub. Date: Oct. 4, 2018

(54) MEDIA RECOMMENDATIONS BASED ON MEDIA PRESENTATION ATTRIBUTES

(71) Applicant: THOMSON Licensing, Issy-les-Moulineaux (FR)

(72) Inventors: Joel M. FOGELSON, Pasadena, CA (US); Arnaud RETUREAU, Los Angeles, CA (US); Samir AHMED, Culver City, CA (US)

(21) Appl. No.: 15/765,141

(22) PCT Filed: Sep. 30, 2015
(86) PCT No.: PCT/US2015/053280

§ 371 Date: Mar. 30, 2018

(51) Int. Cl. G06F 17/30

(52) U.S. Cl. CPC G06F 17/30035

(57) ABSTRACT

Ways to generate content consumption profiles are described. The profiles are used to generate recommendations that match the profiles. A method that generates a profile related to content consumption includes: retrieving (320) a list of content items, identifying (330) an attribute value associated with a presentation attribute for a content item, generating (340) a target attribute value for the content item, the target attribute value indicating at least one of a video mode and an audio mode, and generating (350) the profile based on the target attribute value. A method that generates content recommendations includes retrieving (510) a user profile having a target attribute value related to a presentation attribute, retrieving (540) a list of content items, identifying (550), from the list, content items that match the target attribute value which includes at least one of an audio attribute and a video attribute of the content items, and generating (560) a list of recommended content items.

### BACKGROUND

Many users may consume multimedia content across a range of user devices, such as smartphones, tablets, personal computers, etc. Such media content may include content items with various attributes related to the content and/or presentation quality.

Current content providers do not use content presentation attributes to generate profile or recommendation information. Users may receive recommendations of content in formats that are not appropriate for the user or provide unsatisfactory quality or features for the user.

Therefore there exists a need for ways to determine relevant presentation attributes and generate recommendations based on profile information.

### SUMMARY

Some embodiments may provide ways to identify and collect attributes related to content items. Such attributes may include attributes related to the content, such as genre. In addition, such attributes may include attributes related to presentation and/or quality, such as video resolution or format, audio format, connection speed, device type, etc.

Ways to generate content consumption profiles are described. The profiles are used to generate recommendations that match the profiles. A method that generates a profile related to content consumption includes: retrieving a list of content items, identifying an attribute value associated with a presentation attribute for a content item, generating a target attribute value for the content item, the target attribute value indicating at least one of a video mode and an audio mode, and generating the profile based on the target attribute value. A method that generates content recommendations includes: retrieving a user profile having a target attribute value related to a presentation attribute, retrieving a list of content items, identifying, from the list, content items that match the target attribute value which includes at least one of an audio attribute and a video attribute of the content items, and generating a list of recommended content items.

Content consumption may be analyzed by some embodiments to determine a set of attributes related to the consumed content. Some attributes may be generated based on other criteria such as user selection, default values, etc. Such attributes may be used to generate a user profile that reflects preferred or target attribute values.

The user profile(s) may be used to generate recommendations for content items. Such recommendations may be based on specific profiles (e.g., when making recommendations to a specific user) and/or groups of profiles (e.g., when making recommendations based on user demographic data, group membership, etc.).

The generation of recommended media may utilize various other factors such as time of day, actor, director, length of media asset, year media asset was created or released, co-variance of media assets watched together by other users, etc. The recommended media asset visual and audio characteristics can be developed on a macroscale (for all or most users using a media service), microscale (for a single user consuming content), similar users (users who use a media service with a similar consuming profile), etc.

In addition, the visual and audio profile information can be changed depending on the device that is being used for consuming content to consider viewing habits of a user for such a device. For example, a high definition version or a 4K version of a media asset may be recommended when a user is accessing the media asset using a display device such as a television set, while a standard definition version may be suggested if a user is using a phone.

The recommended version may depend on whether or not a user device has access to a service such as metadata that may allow a regular version of content to be up converted to a higher quality format. For example, a recommended high definition media asset may have two versions available, where the first version is an actual high definition version while a second version may be transmitted using a standard definition stream that is up converted to high definition using metadata. Recommendations may be made among the versions based on various relevant criteria (e.g., user selection, device type, etc.). Different items may include different conversion options. Different exemplary versions may include ultra-high definition, 8K definition, 4K definition, high definition, standard definition, high dynamic range, stand dynamic range, wide color gamut, non-wide color gamut, and the like.

A first aspect provides a method that generates a profile related to content consumption. The method includes: retrieving a list of content items, identifying at least one attribute value associated with at least one presentation attribute for at least one content item, generating at least one target attribute value for the content item, the target attribute value indicating at least one of a video mode and an audio mode, and generating the profile based at least partly on the target attribute value.

A second aspect provides a server that generates profiles related to content consumption. The server includes: a processor for executing a set of instructions, and a non-transitory medium that stores the set of instructions. The set of instructions includes: retrieving a list of content items, identifying at least one attribute value associated with at least one presentation attribute for at least one content item, generating at least one target attribute value for the content item, the target attribute value indicating at least one of a video mode and an audio mode, and generating the profile based at least partly on the target attribute value.

A third aspect provides a method that generates content recommendations. The method includes: retrieving a user profile having at least one target attribute value related to at least one presentation attribute, retrieving a list of content items, identifying, from the list of content items, content items that match the target attribute value, the target attribute value including at least one of an audio attribute and a video attribute of the content items, and generating a list of recommended content items based at least partly on the identified content items.

A fourth aspect provides a server that generates content recommendations. The server includes: a processor for executing a set of instructions; and a non-transitory medium that stores the set of instructions. The set of instructions includes: retrieving a user profile having at least one target attribute value related to at least one presentation attribute, retrieving a list of content items, identifying, from the list of content items, content items that match the target attribute value, the target attribute value including at least one of an audio attribute and a video attribute of the content items, and generating a list of recommended content items based at least partly on the identified content items.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The features of the disclosure are set forth in the appended claims. However, for purpose of explanation, several embodiments are illustrated in the following drawings.

FIG. 1 illustrates a schematic block diagram of an exemplary system of some embodiments;

FIG. 2 illustrates a schematic block diagram of an exemplary system of some embodiments including various system sub-components;

FIG. 3 illustrates a flow chart of an exemplary process used by some embodiments to generate a user profile;

FIG. 4 illustrates a flow chart of an exemplary process used by some embodiments to determine attributes of media content items;

FIG. 5 illustrates a flow chart of an exemplary process used by some embodiments to generate a set of recommendations based on a set of user profiles;

FIG. 6 illustrates a flow chart of an exemplary process used by some embodiments to identify content items that match a set of user profiles; and

FIG. 7 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to generate profiles and use the profiles to identify relevant content items for recommendation. The profiles may include user profiles, device profiles, and/or other types of profiles. Such profiles may include various target attribute values. Such targets may be based on various relevant criteria (e.g., past consumption and what audio/video modes were used, user preference, etc.). The profiles may be used to identify content with matching or similar attribute values.

A first exemplary embodiment provides a method that generates a profile related to content consumption. The method includes retrieving a list of content items, identifying at least one attribute value associated with at least one presentation attribute for at least one content item, generating at least one target attribute value for the content item, the target attribute value indicating at least one of a video mode and an audio mode, and generating the profile based at least partly on the target attribute value.

A second exemplary embodiment provides a server that generates profiles related to content consumption. The server includes a processor for executing a set of instructions, and a non-transitory medium that stores the set of instructions. The set of instructions includes: retrieving a list of content items, identifying at least one attribute value associated with at least one presentation attribute for at least one content item, generating at least one target attribute value for the content item, the target attribute value indicating at least one of a video mode and an audio mode, and generating the profile based at least partly on the target attribute value.

A third exemplary embodiment provides a method that generates content recommendations. The method includes retrieving a user profile having at least one target attribute value related to at least one presentation attribute, retrieving a list of content items, identifying, from the list of content items, content items that match the target attribute value, the target attribute value including at least one of an audio attribute and a video attribute of the content items, and generating a list of recommended content items based at least partly on the identified content items.

A fourth exemplary embodiment provides a server that generates content recommendations. The server includes a processor for executing a set of instructions; and a non-transitory medium that stores the set of instructions. The set of instructions includes retrieving a user profile having at least one target attribute value related to at least one presentation attribute, retrieving a list of content items, identifying, from the list of content items, content items that match the target attribute value, the target attribute value including at least one of an audio attribute and a video attribute of the content items, and generating a list of recommended content items based at least partly on the identified content items.

Several more detailed embodiments are described in the sections below. Section I provides a description of exemplary hardware architectures of some embodiments. Section II then describes various exemplary methods of operations used by some embodiments. Lastly, Section III describes a computer system which implements some of the embodiments.

### I. System Architecture

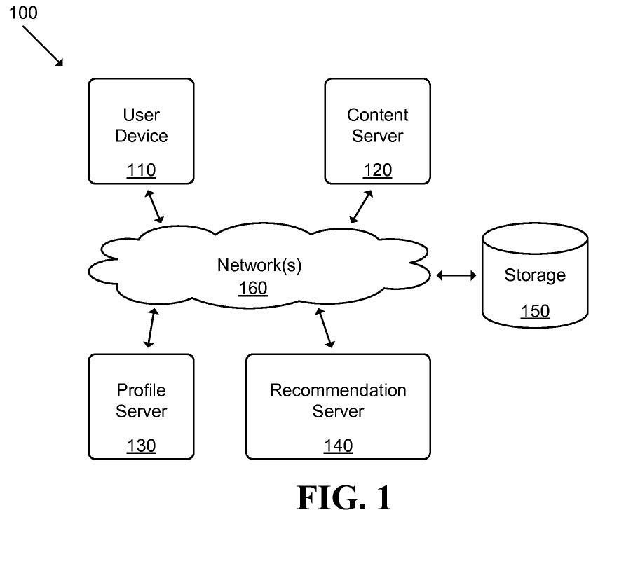

FIG. 1 illustrates a schematic block diagram of an exemplary system 100 of some embodiments. As shown, the system may include a set of user devices 110, one or more content servers 120, one or more profile servers 130, one or more recommendation servers 140, a set of storages 150, and a set of networks 160.

Each user device 110 may be a computing device capable of providing media content to a user. Such devices may include, for instance, smartphones, tablets, personal computers, laptops, televisions, monitors, etc. The user device may be able to communicate with various other system components across one or more networks 160 and/or other appropriate communication channels.

Each content server 120 may be a computing device that is able to communicate across one or more networks 160. The content server 120 may provide multimedia content for consumption using the user device 110. The content server 120 may provide content via various appropriate utilities and/or interfaces. For instance, some user devices 110 may execute a dedicated application that interacts with the content server 120 to provide content via the user device 110. As another example, some user devices 110 may access a content server using a web browser and a web interface. Some embodiments may provide content using one or more application programming interfaces (APIs) such that the content may be accessed by numerous players, web resources, etc.

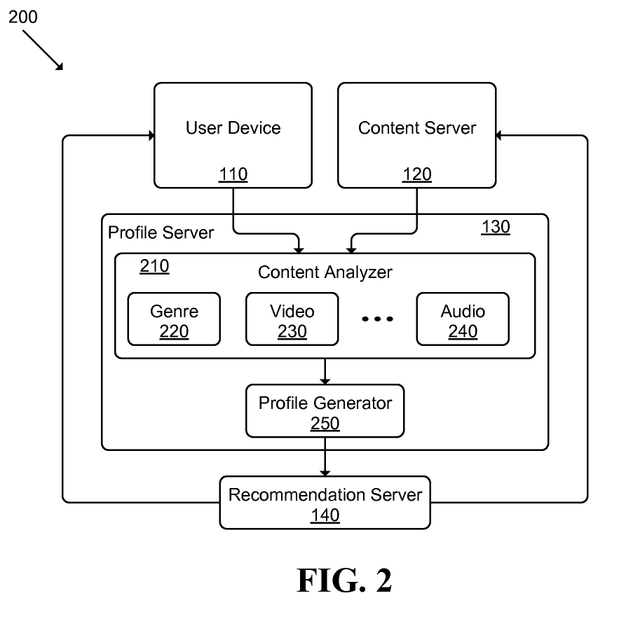

Each profile server 130 may be a computing device that is able to generate, modify, and/or otherwise manage a set of user profiles associated with content consumption. The profile server will be described in more detail in reference to FIG. 2 below.

Each recommendation server 140 may be a computing device that is able to analyze one or more user profiles and generate a set of relevant recommendations from among a set of available content items.

The storages 150 may be local and/or remote devices that are able to receive, store, and/or provide data and/or instructions to other system components. Some system elements may be associated with a local storage (e.g., an internal drive of a computing device) and/or remote storages (e.g., a network accessible storage).

The network(s) 160 may include various wired and/or wireless pathways among components. The networks may include, for instance, Ethernet networks, Wi-Fi networks, cellular networks, local area networks, distributed networks, the Internet, etc.

FIG. 2 illustrates a schematic block diagram of an exemplary system 200 of some embodiments including various system sub-components. Specifically, this figure shows various components of the profile server 130 that may be used to analyze consumed content and generate a set of user profiles. As shown, the profile server includes a content analyzer 210 with a set of attribute analyzers 220-240 and a profile generator 250.

The content analyzer 210 may be able to identify and quantify various attributes associated with content items. In this example, the analyzer includes a genre analyzer 220, a video analyzer 230, and an audio analyzer 240. Different embodiments may include various different attribute analyzers (e.g., length, source, rating, price, etc.). In this example, the genre analyzer 220 may determine a genre (e.g., comedy, reality, action, etc.) associated with the content item. Such a determination may be made based on various relevant factors (e.g., metadata associated with the content item, user reviews, etc.). The video analyzer 230 may determine various video attributes (e.g., resolution, bitrate, etc.) and/or identify one or more video types (e.g., high definition, 4 k, 8 k, high dynamic range (HDR), etc.). The audio analyzer 240 may determine various audio attributes (e.g., stereo, surround sound, 5.1 surround, 7.1 surround, digital theater systems, etc.).

The profile generator 250 may associate the identified and quantified attributes with one or more user profiles (and/or generate one or more such profiles). In some embodiments, the recommendation server 140 may receive profiles and/or content analysis from the profile server 130. The recommendation server 140 may be a computing device that is able to analyze user profile information and/or content information to generate a set of recommendations for a user. Such recommendations may be provided via a user device 110 and/or a content server 120.

During operation, the user device 110 may retrieve content from the content server 120. Such content may be received via various appropriate interfaces (e.g., dedicated application, web browser, etc.). The profile server 130 may receive a list of consumed content items from the user device 110 and/or server 120. The content analyzer 210 may determine various attributes using the attribute analyzers 220-240. The profile generator 250 may analyze the attributes to identify preferences, patterns, tendencies, etc. Such identified patterns may be used to generate at least one user profile. The at least one user profile may be used by the recommendation server 140 to generate a set of recommendations based on analysis of the profile(s). The list of recommendations may be provided to a user device 110 (e.g., via a web browser or dedicated application), content server (e.g., via an API), and/or other appropriate elements.

For example, a first user, using a first device such as a smartphone, may consume content with similar attributes (e.g., a genre of music performance, a video quality of standard definition, and an audio quality of stereo). The first user, using a second device such as a television, may consume content with different attributes (e.g., a genre of sports, a video quality of high definition, and an audio quality of 5.1 surround). Such profiles may be generated for additional users, devices, groups of users, etc. The profile(s) may then be used to identify matching content items that may be suitable for each user based on the user profile(s).

Although the term “quality” may be used throughout the specification to refer to various types of video or audio presentation (and/or other attributes), one of ordinary skill in the art will recognize that the different discrete attribute values may not represent differences in actual quality of presentation (and/or perceived quality) but may instead represent different available formats or options. For example, quality can relate to the resolution of a picture (standard definition, high definition, 4K), color space for a video (non-wide color gamut to wide color gamut), contrast space for video (non-HDR compared to HDR), number of channels used for audio (stereo versus 5.1), and the like.

One of ordinary skill in the art will recognize that systems 100 and 200 may be implemented in various different ways without departing from the scope of the disclosure. For instance, different embodiments may include different numbers of each element, different communication pathways, and/or different arrangements of elements. In addition, some embodiments may include additional elements and/or omit various elements.

### II. Methods of Operation

Some embodiments generate user profiles. A profile engine or other appropriate resource may track the type of content items or “media assets” a user consumes (e.g., based on genre, video quality, etc.).

For example, some embodiments may determine a genre value (e.g., adventure, action, romance, horror, documentary, etc.), a visual quality (e.g., standard definition, high definition, 4K definition, 8K definition, HDR, etc.), and/or audio quality (e.g., stereo, surround sound, 5.1 surround, 7.1 surround, THX, etc.).

Continuing this example, the profiles for a user (and/or group of users) may include one or more values for each attribute. For instance, a first profile associated with a first user may indicate preferred attributes including a genre of adventure, video quality of 4K and HDR, and audio quality of 7.1 surround. The first profile may further define preferred attributes (e.g., video and/or audio attributes) associated with other genres (and/or other relevant parameters or attributes such as playback device, content provider, etc.). For instance, the first profile may further indicate that for a genre of romance, preferences include a video quality of high definition and not HDR and an audio quality of surround sound. The first profile may further indicate that for a genre of documentary, preferences include video quality of standard definition and not HDR, and an audio quality of stereo.

A second profile associated with a second user may indicate preferred attributes including a genre of romance, video quality of 4K, and audio quality of stereo. As above, the second profile may further define preferred attributes associated with other genres (and/or other relevant parameters or attributes). For instance, the second profile may further indicate that for a genre of documentary, preferences include a video quality of high definition and an audio quality of 7.1 surround. The second profile may further indicate that for a genre of adventure, preferences include video quality of high definition and HDR, and an audio quality of 5.1 surround.

Such profiles may be combined in various ways to generate group profiles that indicate preferences across users.

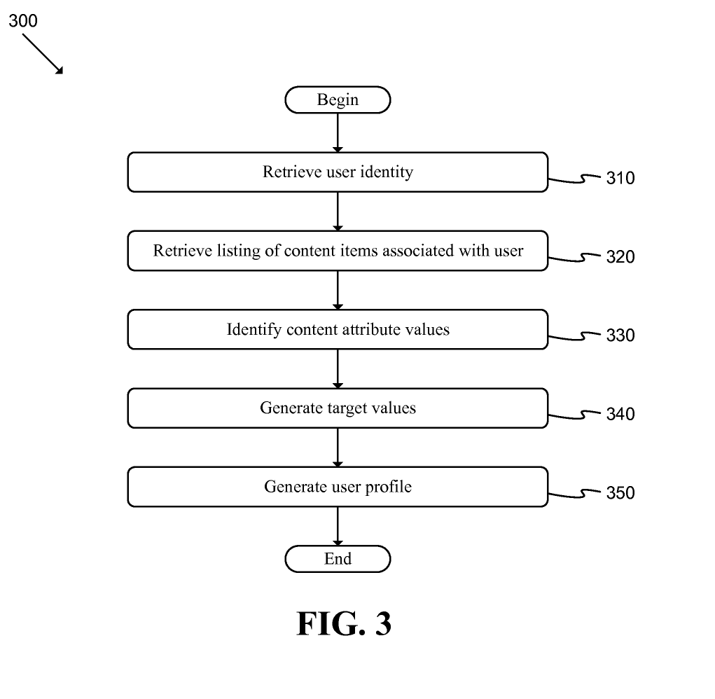

FIG. 3 illustrates a flow chart of an exemplary process 300 used by some embodiments to generate a user profile. Such a process may be executed by a device such as, for example, profile server 130. The process may begin, for instance, when a user selects a content item for playback.

As shown, the process may retrieve (at 310) user identity information. Such information may include information such as a username or other ID, biographic information, and/or other appropriate user information. Such information may also include data related to a group of users (e.g., users with matching demographic information, users associated through a social media group, etc.). Some embodiments may further identify user device information (e.g., type, model, hardware capabilities, etc.). Such information may be identified by communicating with the user device, a server, and/or a data resource (e.g., one or more lookup tables). The information may be received at the profile server 130 from an element such as user device 110, content server 120, and/or other appropriate elements.

Next, the process may retrieve (at 320) a listing of content items associated with the user (and/or group of user). The listing may be received at the profile server 130 from an element such as user device 110, content server 120, and/or other appropriate devices. Such a listing may include a list of content identifiers (e.g., name, identification number, etc.), a list of content providers, and/or other relevant information. The listing of content items may also include data related to viewing of the media, such as playback device type (e.g., smartphone, tablet, etc.), content provider, connection speed or network type, and/or other appropriate information (e.g., duration or viewing time, viewing date and/or time, etc.).

The process may then identify (at 330) a set of content attribute values. Such a determination may be made by a content analyzer and/or various attribute analyzers. The set of content attributes may include genre, video quality, audio quality, and/or other appropriate attributes. The set of content attributes may be defined by, for instance, a content provider, user preferences, system capabilities, etc.

Next, the process may generate (at 340) a set of target attribute values. Such a set may include discrete values (e.g., action, high definition, stereo, etc.), weighted lists of values (e.g., a list sorted by percentage of content consumed with that attribute value, such as eighty-five percent action, ten percent sports, five percent music videos), etc. The target values may be generated in various appropriate ways. For instance, the set of content attribute values identified at 330 may be analyzed to determine the number of items that match any particular value. The target values may be based on the highest ranked item (and/or items) associated with each attribute. There may be multiple target values for each attribute, where the multiple values may be ranked or weighted based on the number of matches. In some embodiments, the target attribute values may be at least partly based on user selections (e.g., a user may indicate a preference for certain attribute values).

Next, the process may generate (at 350) a user profile (or set of user profiles) and then may end. The profile may be provided to appropriate resources, such as recommendation server 140, storage 150, etc. Stored profiles may be accessed by other elements via an appropriate resource such as profile server 130, an API associated with a profile storage, etc.

In some embodiments, the profile(s) may be at least partly based on explicit selections made by users, default selections, etc. For instance, a user may elect to only be shown recommendations for high definition content regardless of whether the user may view other types of content.

Some embodiments may generate a user device profile in a similar manner. The device profile may be based on content previously consumed using the device, user preference, device capabilities, and/or other relevant factors. The device profile may include attributes related to content (e.g., genre, video quality, audio quality, etc.), device hardware (e.g., screen resolution, audio outputs, etc.), and/or other appropriate attributes (e.g., network type, connection speed, etc.).

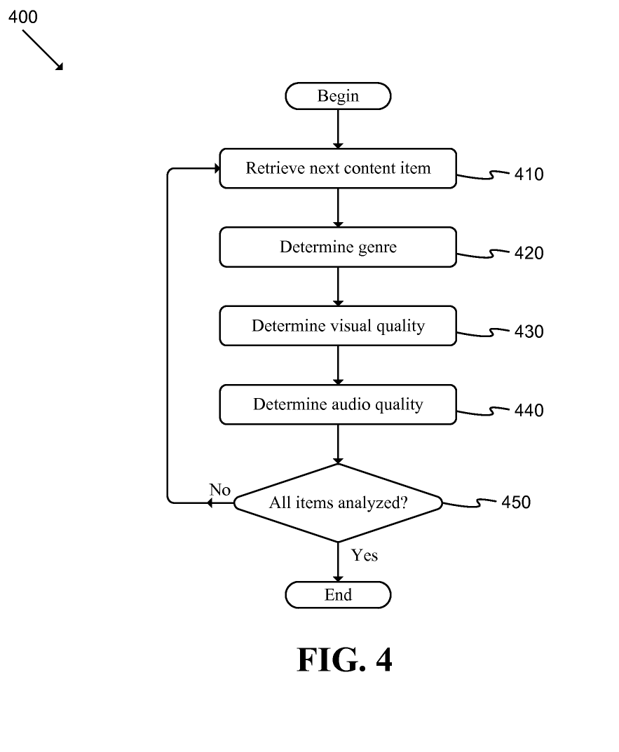

FIG. 4 illustrates a flow chart of an exemplary process 400 used by some embodiments to determine attributes of media content items. Such a process may be executed by a device such as, for example, profile server 130 which may utilize content analyzer 210 and profile generator 250. Process 400 may be performed, for instance, as a portion of operation 330 described above. The process may begin, for instance, when a list of content items associated with a user or group of users is available. Such a list may be retrieved from a resource such as user device 110, content server 120, storage 150, etc.

As shown, process 400 may retrieve (at 410) a next content item from the list. Next, the process may determine (at 420) a genre associated with the content item. The process may then determine (at 430) a visual quality associated with the content item. Process 400 may then determine (at 440) an audio quality associated with the content item. Different embodiments may determine the values of fewer attributes, additional attributes, and/or different types of attributes.

The attribute values may be determined in various appropriate ways. For instance, some attributes may be included in metadata and/or otherwise embedded in the content itself. As another example, the content may be designated using an identifier such as a title which may then be used to retrieve attribute values from a database or other appropriate source. As still another example, the content may be analyzed (e.g., by examining at least a portion of a bit stream associated with streaming content) to determine the attribute values.

Next, the process may determine (at 450) whether all content items have been analyzed. If not the process may repeat operations 410-450 until the process determines (at 450) that all content items in the list have been analyzed and then may end.

Some embodiments may generate recommendations for media assets of particular genres that conform to visual and audio attribute values that have been determined for such genres. For example, if an adventure movie is recommended to a user for purchase or rental, using profile information determined above, the version of the media asset recommended may be a 4K or HDR version using 7.1 surround sound quality, whereas a documentary version that is in standard definition using stereo may be recommended.

The recommendations may be generated utilizing other factors such as time of day criteria, actor, director, length of media asset, year of media asset was created, co-variance of media assets watched together by other users, etc. The recommended media asset visual and audio characteristics may be developed on a macroscale (for all or most users using a media service), microscale (for a single user consuming content), similar users (users who use a media service with a similar consuming profile), etc. In addition, the visual and audio profile information may change depending on the device that is being used for consuming content to consider a viewing habits of a user for such a device.

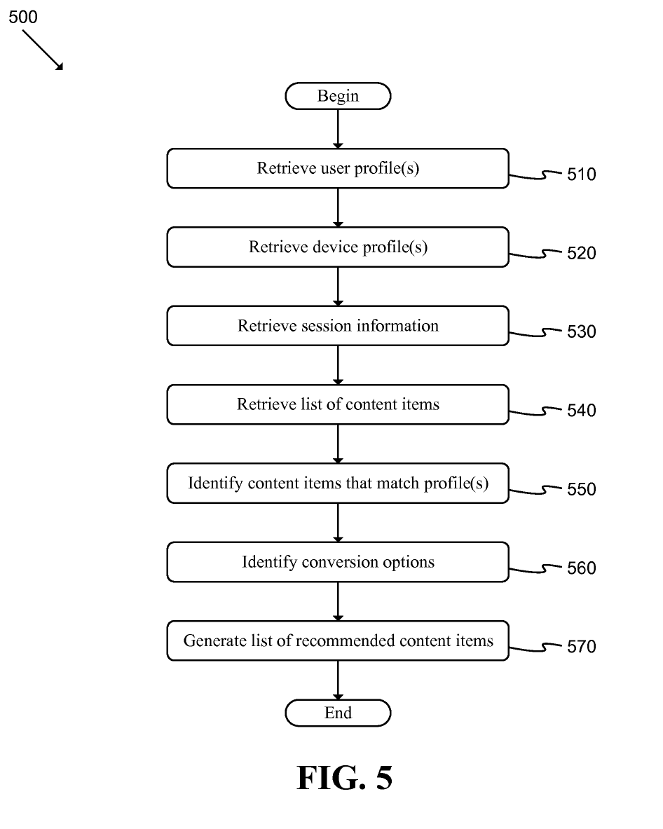

FIG. 5 illustrates a flow chart of an exemplary process 500 used by some embodiments to generate a set of recommendations based on a set of user profiles. Such a process may be executed by a device such as, for example, recommendation server 140. The process may begin, for instance, when a user accesses a streaming media service, launches a media player or other appropriate application, etc.

As shown, process 500 may retrieve (at 510) a user profile or set of user profiles. Such profiles may be retrieved from a resource such as profile server 130. Each user profile may include information related to the user (such as identifying information), content consumed by the user, attribute preferences, etc. Such a profile may be generated using, for example, processes 300 and 400 described above.

Next, process 500 may retrieve (at 520) a set of device profiles. Such device profiles may include information such as, for instance, user or viewer, device type, display size, audio hardware, etc. The device profiles may be associated with the user profiles in various ways (e.g., a particular user may access a content provider through a set of authorized devices such as a smartphone, tablet, and television and the profiles may be linked or otherwise associated). In some cases, the devices profile(s) may be integrated into the user profile(s).

Each device profile may include device information that may be used to define various target attribute values. For instance, a user profile may indicate a preference for stereo audio content. However, if the user is accessing content on a device with only one speaker, the device profile may override the user profile and seek recommendations that are not limited to stereo audio. As another example, the display resolution and/or other capabilities of a device (e.g., three-dimensional viewing, connection type, etc.) may be used to seek recommendations that may not match a user profile generated using a different device with different capabilities.

The process may then retrieve (at 530) session information. Such information may be related to a current consumptions session. For instance, when a user accesses content through a web site, the site may be able to identify various attributes associated with the session. Such session attributes may include device type, connection type or speed, time of day, etc. The session information may affect the attribute values associated with a user profile. For instance, a user may consume only high definition content when viewing media on a television associated with the user but may view lower definition content when viewing media on a smartphone or tablet associated with the user. Such attribute values may be affected by combinations of devices used for a viewing session. For instance, preferred audio attributes may be different for a smartphone user depending on whether headphones are connected to the device.

Next, the process may retrieve (at 540) a list of content items. Such a list may be retrieved from various appropriate resources, such as content providers, and may include items currently available for consumption. In addition to identifying the content items, the list may include attribute information associated with each content item, and/or other relevant information (e.g., popularity ranking, discounts or incentives, release date, etc.).

Process 500 may then identify (at 550) content items from the list of content items that match the profile(s). Such identification may be performed in various appropriate ways.

For instance, some embodiments may use a “knockout” evaluation where each attribute value is compared to a target attribute value. If the values don't match, the content item may be removed from the list (e.g., if a user profile limits the genre to action only, any content item that is not associated with that genre may be removed from the list). Such an algorithm may be further applied to different attributes (e.g., a list that has been filtered to include only action genre content items may be further filtered to include only high definition or better versions of such content). The knockout method may thus be applied to multiple attributes and/or target values, with any remaining items provided as primary options to the user. Such options may be presented in a ranked list where the ranking is based on various appropriate criteria (e.g., popularity, compiled review rating, viewings, etc.).

As another example, some embodiments may rank (and/or re-rank or re-order) the content items based on a matching level compared to an attribute value list. For instance, if a user consumes a large amount of high definition content spread across multiple genres, the ranking may elevate high definition content with less regard to genre. Such ranking may be based on matching across multiple attributes. For instance, a content item that matches all available attributes may be ranked higher than a content item that does not match one or more attributes. In some cases, only content items that match all attributes may be presented to a user.

As still another example, some embodiments may rank content items by considering matching versus user profile and/or device profile criteria. Thus, if a user prefers action movies, a bonus or positive incremental rating may be applied to movies that match that genre. The list of content items may be further refined using additional positive matching attributes. For instance, to continue this example, whether a movie matches the action genre or not, the content item may be increased in rank or otherwise promoted based on a match to other user criteria (e.g., preference for high definition or better video quality content). The items may then be ranked based on a matching “score” or other compilation of the matching versus the specified criteria. In addition, such rankings may be weighted based on the importance of each criterion.

Some embodiments may determine a similarity between a target attribute value and the value associated with a content item. For instance, a user may have a preference for 7.1 surround and a content item with 5.1 surround may be determined to be more similar to the preferred value than a content item with stereo sound.

Some embodiments may use negative attribute values (e.g., not HDR, not surround sound, etc.). In such cases, the recommendations may be based on eliminating content that matches the negative attribute values. Such negative values may also be used in other various ways described above (e.g., ranking, determination of similarity, etc.).

Throughout this disclosure, the term “match” may be used to refer to any of the above evaluation schemes. Multiple schemes may be used to identify matching content in some cases.

After identifying (at 550) the content items that match the user profile(s), and identify (at 560) any conversion options associated with the matching content items. For example, some content may be associated with metadata that may be used to up convert the content. In such cases, multiple recommendations may be associated with a single stream and/or a single recommendation may be associated with multiple versions of a stream.

Next, the process may generate (at 570) a list of recommended content items that may include only the matching items and then may end. Some embodiments may rank or order the list according to a matching level. Such a ranked list may include all content items received at 540. The list of recommendations may be provided to a user device (e.g., via a web browser, playback application, etc.), server, and/or other appropriate resource for presentation to the user (and/or groups of users).

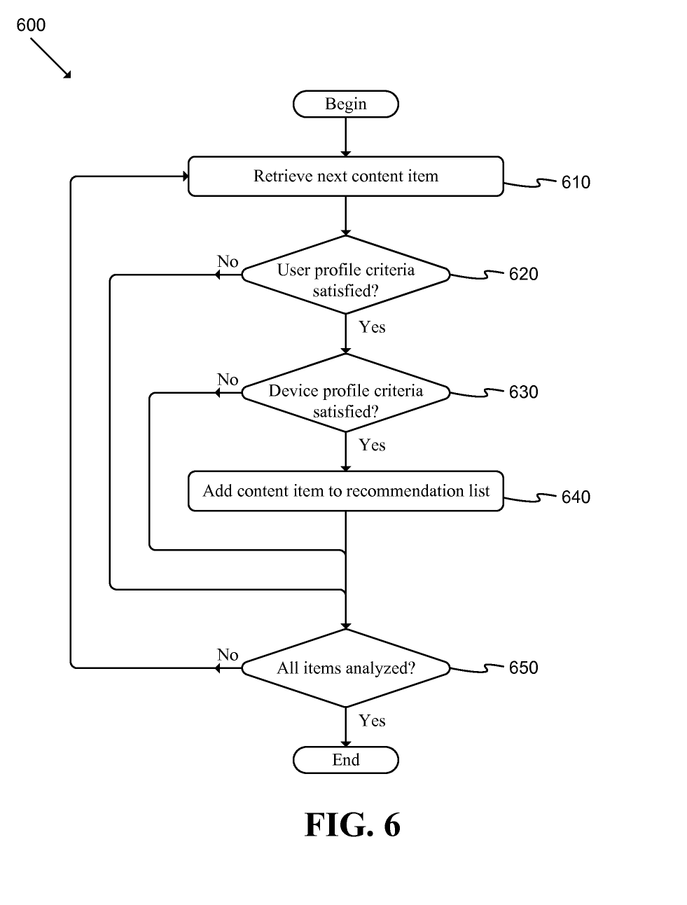

FIG. 6 illustrates a flow chart of an exemplary process 600 used by some embodiments to identify content items that match a set of user profiles. Such a process may be executed by a device such as, for example, recommendation server 140. The process may be performed, for instance, as a portion of operation 550 described above. Process 600 may begin, for instance, when a list of content items is retrieved. Such a list may be retrieved from a resource such as user device 110, content server 120, storage 150, etc.

As shown, process 600 may retrieve (at 610) a next content item from the list. Next, the process may determine (at 620) whether any user profile criteria are satisfied. Such criteria may include a set of target attribute values associated with the user. If the process determines (at 620) that the user profile criteria are satisfied, the process may then determine (at 630) whether any device profiler criteria are satisfied. Such criteria may include a set of target attribute values associated with the device. If the process determines (at 630) that the device profile criteria are satisfied, the process may then add (at 640) the content item to a recommendation list. In addition, if there are other items in the list, the process may rank or order the items depending on various appropriate criteria (e.g., matching level, popularity, etc.).

If the process determines (at 620) that the content item does not satisfy the user profile criteria, if the process determines (at 630) that the content item does not satisfy the device profile criteria, or after adding (at 640) the content item to the recommendation list, the process may determine (at 650) whether all items in the list have been analyzed. If the process determines (at 650) that all items have not been analyzed, the process may repeat operations 610-650 until the process determines (at 650) that all items have been analyzed and then may end.

In some embodiments, the recommendations may depend at least partly on whether or not a service such as metadata is available to allow up conversion into a higher quality format. For example, a recommended media asset having high definition video may have two versions available where the first version is an actual high definition version and a second version may generate high definition from a standard definition stream using metadata that is transmitted with the stream. The metadata may be used by a display device to up convert the standard definition to high definition. The high definition or up converted version may be recommended based on various relevant criteria such as user selection or preference, available transmission bandwidth (e.g., an up converted version may utilize less bandwidth), processing capability of a user device (e.g., up converting media at the user device may utilize additional processing power).

One of ordinary skill in the art will recognize that processes 300, 400, 500, and/or 600 may be implemented in various different ways without departing from the scope of the disclosure. For instance, different embodiments may perform the operations in different orders than shown. As another example, some embodiments may include additional operations and/or omit some operations. Each process may be divided into a set of sub-processes and/or included as part of a larger macro process. Each process (and/or portions thereof) may be performed iteratively, based on some appropriate criteria.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

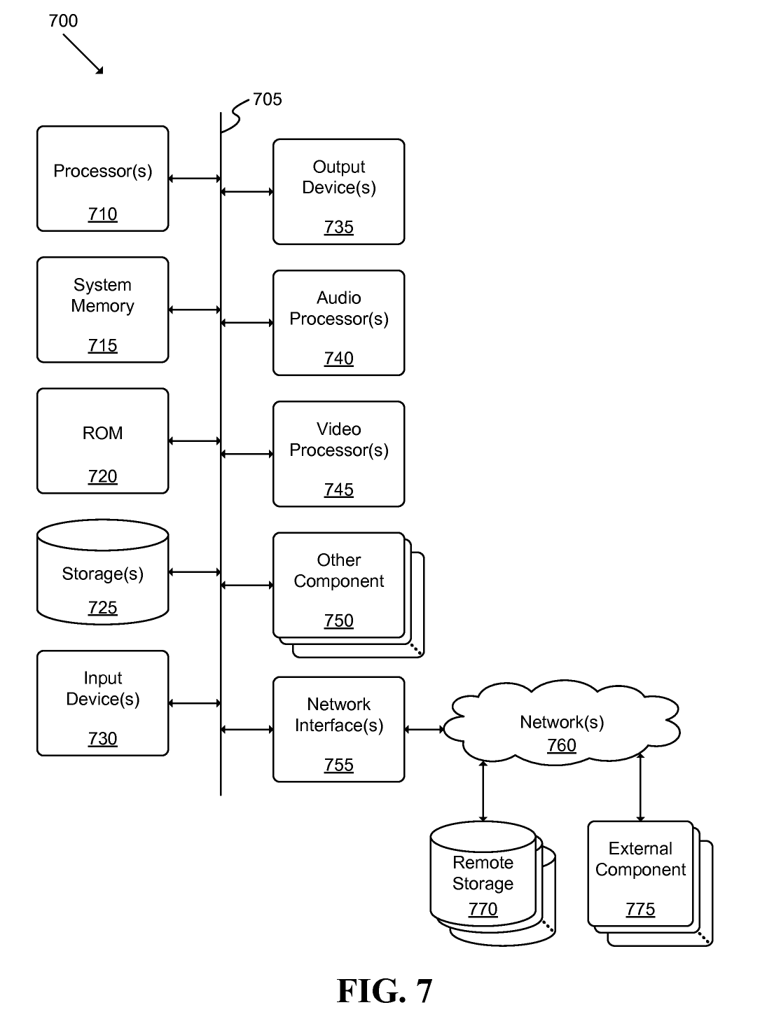

FIG. 7 illustrates a schematic block diagram of an exemplary computer system 700 used to implement some embodiments. For example, the system described above in reference to FIGS. 1-2 may be at least partially implemented using computer system 700. As another example, the processes described in reference to FIGS. 3-6 may be at least partially implemented using sets of instructions that are executed using computer system 700.

Computer system 700 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 700 may include at least one communication bus 705, one or more processors 710, a system memory 715, a read-only memory (ROM) 720, permanent storage devices 725, input devices 730, output devices 735, audio processors 740, video processors 745, various other components 750, and one or more network interfaces 755.

Bus 705 represents all communication pathways among the elements of computer system 700. Such pathways may include wired, wireless, optical, and/or other appropriate communication pathways. For example, input devices 730 and/or output devices 735 may be coupled to the system 700 using a wireless connection protocol or system.

The processor 710 may, in order to execute the processes of some embodiments, retrieve instructions to execute and/or data to process from components such as system memory 715, ROM 720, and permanent storage device 725. Such instructions and data may be passed over bus 705.

System memory 715 may be a volatile read-and-write memory, such as a random access memory (RAM). The system memory may store some of the instructions and data that the processor uses at runtime. The sets of instructions and/or data used to implement some embodiments may be stored in the system memory 715, the permanent storage device 725, and/or the read-only memory 720. ROM 720 may store static data and instructions that may be used by processor 710 and/or other elements of the computer system.

Permanent storage device 725 may be a read-and-write memory device. The permanent storage device may be a non-volatile memory unit that stores instructions and data even when computer system 700 is off or unpowered. Computer system 700 may use a removable storage device and/or a remote storage device as the permanent storage device.

Input devices 730 may enable a user to communicate information to the computer system and/or manipulate various operations of the system. The input devices may include keyboards, cursor control devices, audio input devices and/or video input devices. Output devices 735 may include printers, displays, audio devices, etc. Some or all of the input and/or output devices may be wirelessly or optically connected to the computer system 700.

Audio processor 740 may process and/or generate audio data and/or instructions. The audio processor may be able to receive audio data from an input device 730 such as a microphone. The audio processor 740 may be able to provide audio data to output devices 740 such as a set of speakers. The audio data may include digital information and/or analog signals. The audio processor 740 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 745 (or graphics processing unit) may process and/or generate video data and/or instructions. The video processor may be able to receive video data from an input device 730 such as a camera. The video processor 745 may be able to provide video data to an output device 740 such as a display. The video data may include digital information and/or analog signals. The video processor 745 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 750 may perform various other functions including providing storage, interfacing with external systems or components, etc.

Finally, as shown in FIG. 7, computer system 700 may include one or more network interfaces 755 that are able to connect to one or more networks 760. For example, computer system 700 may be coupled to a web server on the Internet such that a web browser executing on computer system 700 may interact with the web server as a user interacts with an interface that operates in the web browser. Computer system 700 may be able to access one or more remote storages 770 and one or more external components 775 through the network interface 755 and network 760. The network interface(s) 755 may include one or more application programming interfaces (APIs) that may allow the computer system 700 to access remote systems and/or storages and also may allow remote systems and/or storages to access computer system 700 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 700 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that generates a profile related to content consumption, the method comprising:
retrieving a list of content items;
identifying at least one attribute value associated with at least one presentation attribute for at least one content item;
generating at least one target attribute value for said content item, the target attribute value indicating at least one of a video mode and an audio mode; and
generating the profile based at least partly on the target attribute value.

2. The method of claim 1, wherein the presentation attributes comprise at least one genre that is associated with at least one of a particular video mode, and a particular audio mode.

3. The method of claim 1 further comprising:
retrieving a user identifier associated with a user; and
associating the user identifier with the profile.

4. The method of claim 3 further comprising:
identifying a user device associated with the user;
retrieving a set of device attribute values associated with a user device;
determining a set of target device attribute values; and
associating the set of target device attribute values with the profile.

5. The method of claim 3, wherein the list of content items comprises content items previously consumed by the user.

6. A server that generates profiles related to content consumption, the server comprising:
a processor for executing a set of instructions; and
a non-transitory medium that stores the set of instructions, wherein the set of instructions comprises:
retrieving a list of content items;
identifying at least one attribute value associated with at least one presentation attribute for at least one content item;
generating at least one target attribute value for said content item, the target attribute value indicating at least one of a video mode and an audio mode; and
generating the profile based at least partly on the target attribute value.

7. The server of claim 6, wherein the presentation attributes comprise at least one genre that is associated with at least one of a particular video mode, and a particular audio mode.

8. The server of claim 6, wherein the set of instructions further comprises:
retrieving a user identifier associated with a user; and
associating the user identifier with the profile.

9. The server of claim 8, wherein the set of instructions further comprises:
identifying a user device associated with the user;
retrieving a set of device attribute values associated with a user device;
determining a set of target device attribute values; and
associating the set of target device attribute values with the profile.

10. The server of claim 8, wherein the list of content items comprises content items previously consumed by the user.

11. A method that generates content recommendations, the method comprising:
retrieving a user profile having at least one target attribute value related to at least one presentation attribute;
retrieving a list of content items;
identifying, from the list of content items, content items that match the target attribute value, the target attribute value comprising at least one of an audio attribute and a video attribute of the content items; and
generating a list of recommended content items based at least partly on the identified content items.

12. The method of claim 11 further comprising.
retrieving a device profile;
identifying, from the list of recommended content items, recommended content items that match the device profile; and
updating the list of recommended content items based at least partly on the identified recommended content items.

13. The method of claim 11, wherein the presentation attributes comprise genre, video quality, and audio quality.

14. The method of claim 11 further comprising:
identifying, from the list of recommended content items, recommended content items that content items that have associated conversion options, wherein at least one associated conversion option matches the user profile; and
updating the list of recommended content items based at least partly on the identified recommended content items.

15. The method of claim 11, wherein the set of target attribute values comprises sets of discrete values, each set of discrete values associated with a particular presentation attribute from the set of presentation attributes.

16. A server that generates content recommendations, the server comprising:
a processor for executing a set of instructions; and
a non-transitory medium that stores the set of instructions, wherein the set of instructions comprises:
retrieving a user profile having at least one target attribute value related to at least one presentation attribute;
retrieving a list of content items;
identifying, from the list of content items, content items that match the target attribute value, the target attribute value comprising at least one of an audio attribute and a video attribute of the content items; and
generating a list of recommended content items based at least partly on the identified content items.

17. The server of claim 16, wherein the set of instructions further comprises.
retrieving a device profile;
identifying, from the list of recommended content items, recommended content items that match the device profile; and
updating the list of recommended content items based at least partly on the identified recommended content items.

18. The server of claim 16, wherein the presentation attributes comprise genre, video quality, and audio quality.

19. The server of claim 16, wherein the set of instructions further comprises:
identifying, from the list of recommended content items, recommended content items that content items that have associated conversion options, wherein at least one associated conversion option matches the user profile; and
updating the list of recommended content items based at least partly on the identified recommended content items.

20. The server of claim 16, wherein the set of target attribute values comprises sets of discrete values, each set of discrete values associated with a particular presentation attribute from the set of presentation attributes.
